(19) United States
(12) Patent Application Publication
(10) Pub. No.: US 2012/0306618 A1
(43) Pub. Date: Dec. 6, 2012

(54) REMOTE KEYLESS ENTRY RELAY MODULE AND SYSTEM

(75) Inventors: CRAIG A. TIEMAN, WESTFIELD, IN (US); MARK C. PETERSON, CARMEL, IN (US)

(73) Assignee: DELPHI TECHNOLOGIES, INC., TROY, MI (US)

(21) Appl. No.: 13/118,844

(22) Filed: May 31, 2011

(51) Int. Cl. G05B 19/02

(52) U.S. Cl. 340/5.64

(57) ABSTRACT

A system and in-vehicle communication module for relaying a remote keyless entry command from a cellular network to a vehicle keyless entry receiver. The module include a cellular network receiver configured to receive a remote keyless entry command from a cellular network; and a keyless entry transmitter located in the vehicle and in communication with the cellular network receiver. The keyless entry transmitter is configured to transmit a remote keyless entry signal to a vehicle keyless entry receiver in the vehicle in order to execute a vehicle operation. By sending a remote keyless entry signal to a vehicle remote keyless entry system, installation and engineering costs can be reduced.

### TECHNICAL FIELD OF INVENTION

The invention generally relates to a communication module for relaying a remote keyless entry command to a vehicle keyless entry receiver, and more particularly relates to a module with a keyless entry transmitter located in the vehicle and configured to transmit a remote keyless entry signal to the vehicle keyless entry receiver.

### BACKGROUND OF INVENTION

Many vehicles are equipped with remote keyless entry (RKE) systems that operate certain aspects of the vehicle in response to a signal from a key fob, such as locking or unlocking the vehicle doors, or starting the vehicle. However, the range of these key fobs is typically limited, and vehicle operator's must carry and maintain the key fob along with other electronic devices most people already carry, such as a personal communication device.

### SUMMARY OF THE INVENTION

In accordance with one embodiment of this invention, an in-vehicle communication module for relaying a remote keyless entry command from a cellular network to a vehicle keyless entry receiver is provided. The module includes a cellular network receiver and a keyless entry transmitter. The cellular network receiver is configured to receive a remote keyless entry command from a cellular network. The keyless entry transmitter is located in the vehicle and is in communication with the cellular network receiver. The keyless entry transmitter is configured to transmit a remote keyless entry signal to a vehicle keyless entry receiver in the vehicle in order to execute a vehicle operation. The remote keyless entry signal corresponds to the remote keyless entry command.

In another embodiment of the present invention, the keyless entry transmitter includes a remote keyless entry key fob circuit board assembly. The module is coupled to the remote keyless entry key fob circuit board assembly in a manner effective for the module to operate the remote keyless entry key fob circuit board assembly to transmit a remote keyless entry signal.

In yet another embodiment of the present invention, a communication system for relaying a remote keyless entry command from a personal communications device to a vehicle keyless entry receiver is provided. The system includes a personal communication device, a cellular network receiver, and a keyless entry transmitter. The personal communication device is configured to send a remote keyless entry command via a cellular network. The cellular network receiver is located in a vehicle. The cellular network receiver is configured to receive the remote keyless entry command from the cellular network. The keyless entry transmitter is located in the vehicle and is in communication with the cellular network receiver. The keyless entry transmitter is configured to transmit a remote keyless entry signal to a vehicle keyless entry receiver in the vehicle in order to execute a vehicle operation. The remote keyless entry signal corresponds to the command message.

Further features and advantages of the invention will appear more clearly on a reading of the following detailed description of the preferred embodiment of the invention, which is given by way of non-limiting example only and with reference to the accompanying drawings.

### BRIEF DESCRIPTION OF DRAWINGS

The present invention will now be described, by way of example with reference to the accompanying drawings, in which:

FIG. 1 is block diagram of a remote keyless entry system in accordance with one embodiment; and

FIG. 2 is block diagram of a relay module of FIG. 1 in accordance with one embodiment.

### DETAILED DESCRIPTION OF INVENTION

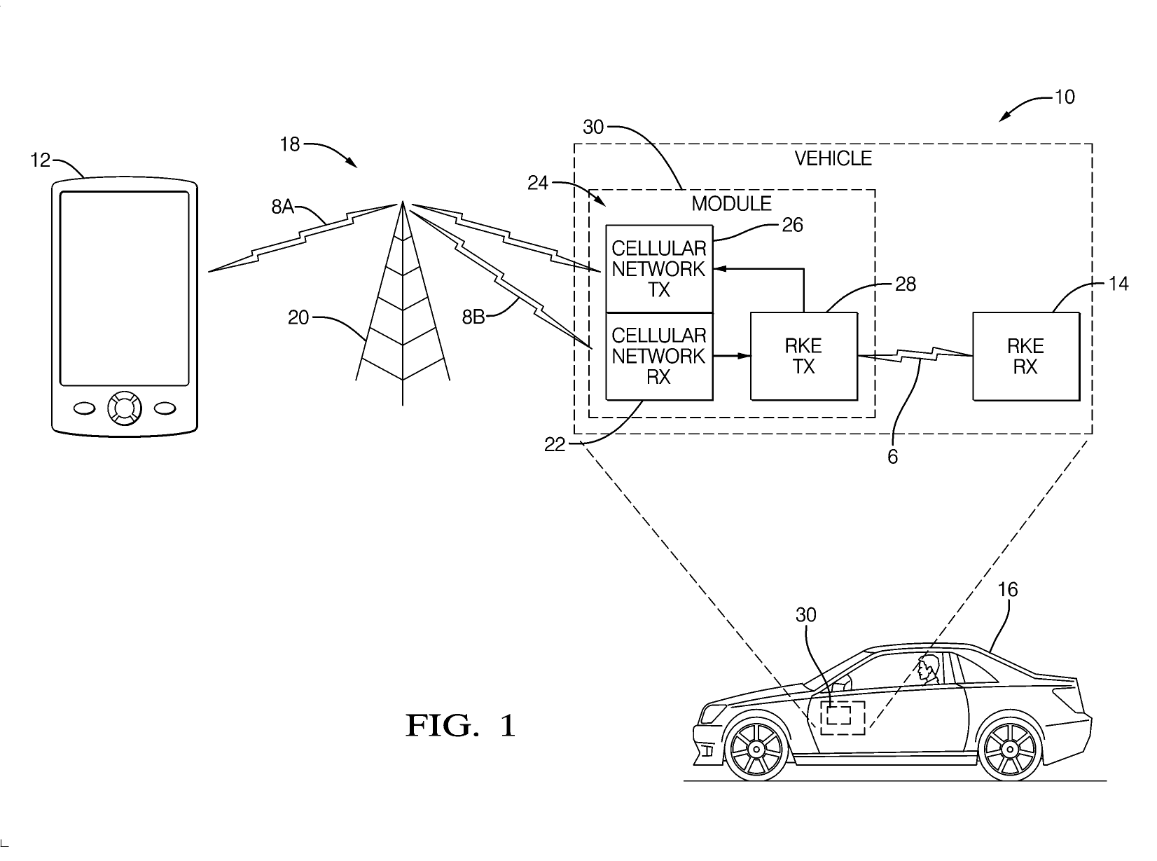

FIG. 1 illustrates a non-limiting example of a communication system 10 for relaying a remote keyless entry (RKE) command 8A, 8B from a personal communications device (PCD) 12 to a vehicle keyless entry receiver 14 that is within a vehicle 16. The vehicle keyless entry receiver 14 will typically be part of a factory installed, original equipment manufacturer (OEM) remote keyless entry system. However, as will become apparent, the system 10 will also interface with after-market remote keyless entry systems. Non-limiting examples of RKE commands include, but are not limited to: a lock doors command, an unlock door command, a start engine command, a flash lights command, and a sound horn command.

In general, the PCD 12 is configured to send a RKE command 8A to the cellular network 18, and the cellular network retransmits the RKE command 8B. The PCD 12 may be, for example, but not limited to, a cellular phone, personal data assistant (PDA), a smart phone such as a Blackberry® or iPhone®, or other such devices. The cellular network 18 may be a distributed network of communication nodes typically associated with a cellular phone network, where one of these nodes may be an antenna tower 20, as illustrated in FIG. 1. Alternatively, the cellular network 18 may include or be formed by a network of internet communication nodes such as a network of Wi-Fi™ hot spots (not shown), or may include or be a network satellites (not shown).

The system 10 may include a cellular network receiver 22 that is located in the vehicle 16. In general, the cellular network receiver 22 is configured to receive a RKE command 8B from the cellular network 18. The cellular network receiver 22 may be part of a cellular network transceiver 24 that includes a cellular network transmitter 26. A suitable example of a cellular network transceiver is a radioOne® RF Processor from Qualcomm. The cellular network transceiver 24 may be assigned a phone number if the system 10 is communicating with a cell phone network, or may be assigned an Internet Protocol address (IP address) if the system 10 is communicating with a network of Wi-Fi™ hot spots.

The system 10 may include a keyless entry transmitter 28 located in the vehicle 16 and in communication with the cellular network receiver 22, for example via wires, fiber optics, or other suitable signal conductor. In general, the keyless entry transmitter 28 is configured to transmit a radio frequency type remote keyless entry signal 6 to the vehicle keyless entry receiver 14 that is also located in the vehicle 16, in order to execute a vehicle operation such as: lock the vehicle doors, unlock a vehicle door, start the vehicle engine, flash the vehicle lights, or sound the vehicle horn. As such, the remote keyless entry signal 6 transmitted by the keyless entry transmitter 28 may be characterized as corresponding to the RKE command 8A, 8B transmitted by the PCD 12 and retransmitted by the cellular network 18, respectively.

The cellular network receiver 22 and the keyless entry transmitter 28 may be assembled together to form an in-vehicle communication module 30 for relaying the remote keyless entry command 8B from the cellular network 18 to the vehicle keyless entry receiver 14. As used herein, the term relaying generally means receiving a wireless signal conveying information at one carrier frequency, and transmitting at least part of or a reformatted version of the information at a different carrier frequency. For example, the remote keyless entry command 8B, may characterized as conveying information and having a first carrier frequency typically associated with cellular networks, and the remote keyless entry signal 6 may be characterized as conveying at least part of that information at a second carrier frequency typically associated with remote keyless entry systems.

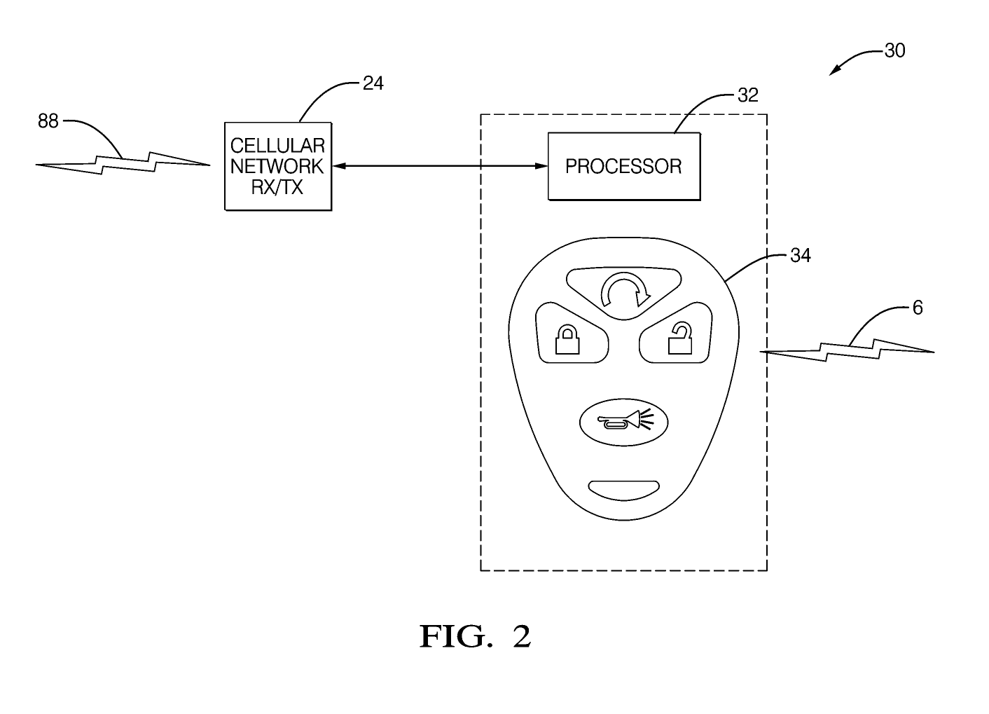

FIG. 2 illustrates a non-limiting example of the module 30. The module 30 may include a processor 32 such as a microprocessor or other control circuitry as should be evident to those in the art. The processor 32 may include memory, including non-volatile memory, such as electrically erasable programmable read-only memory (EEPROM) for storing one or more routines, thresholds and captured data. The one or more routines may be executed by the processor 32 to perform steps for determining if signals received by the cellular network transceiver 24 are valid for executing a vehicle operation as described herein.

FIG. 2 illustrates the keyless entry transmitter 28 as including an actual key fob, but this is only for the purpose of explanation and not limitation. In one embodiment, the key fob 34 may actually be a programmable transmitter that transmits the remote keyless entry signal 6 according to settings received from the processor 32. In another embodiment, a circuit board assembly may be removed from the key fob 34 and electrically connected to the processor by way of pressure based electrical contacts or by soldering wires to the circuit board assembly. While not specifically shown in FIG. 2, it is well known that such a circuit board assembly has contact pads that physically align with the buttons illustrated on the key fob 34. In yet another embodiment the processor may operate mechanical actuators (not shown) that press the buttons of the key fob in order to transmit a remote keyless entry signal 6.

For any of the embodiments described above, the keyless entry transmitter 28 transmits a remote keyless entry signal 6 that is essentially the same as what would be transmitted when a person pressed a button on a remote keyless entry key fob in their possession. Because of this feature, the module 30 may be installed almost anywhere in the vehicle 16 in order to enable the PCD 12 to execute various vehicle operations such as those described above. Since many vehicles are assembled with factory installed remote keyless entry (RKE) systems that provide the vehicle keyless entry receiver 14, adding the module 30 is little more than providing a source of power for the module 30, programming the module 30 with a phone number so the cellular network 18 can establish communication with the cellular network receiver 22, and programming the keyless entry transmitter 28 with the necessary codes so the vehicle keyless entry receiver 14 recognizes the remote keyless entry signal 6 as being authorized to execute a vehicle operation. This programming may be by way of connecting the module 30 to a personal computer (not shown), or for the case where the key fob 34 is actually a programmable transmitter, by way of the module ‘learning’ the codes from the remote keyless entry system in the vehicle, where this learning method is known.

The processor 32 may also be configured to send messages to the cellular network 18 by way of the cellular network transmitter 26 that may be part of the cellular network transceiver 24. As such, the module 30 may be configured to send a confirmation message to the PCD 12 via to the cellular network 18 for providing confirmation that a remote keyless entry command 8B was received.

In an alternative embodiment, the cellular network transceiver 24 may be replaced by a short range transceiver such as a Bluetooth™ transceiver, and communication to the cellular network 18 may be by way of a second personal communication device located in the vehicle 16, or an in-vehicle cellular radio (not shown), such as an On-Star® in-vehicle cellular radio. As such, the module 30 may be configured to communicate with cellular network 18 via an in-vehicle cellular radio.

Accordingly, a system 10, a module 30 for relaying a remote keyless entry command 8A, 8B from a cellular network 18 to a vehicle keyless entry receiver 14 is provided. The system 10 and module 30 have a particular advantage over systems having a wired data communication path to the vehicle 10 because determining the proper wiring connection and command codes for a wired connection can be very time consuming and expensive, particularly if the vehicle manufacturer is not cooperative. By making use of an already installed remote keyless access system via the vehicle keyless entry receiver 14, the engineering cost may be reduced, and the installation can be very simple.

While this invention has been described in terms of the preferred embodiments thereof, it is not intended to be so limited, but rather only to the extent set forth in the claims that follow.

We claim:

1. An in-vehicle communication module for relaying a remote keyless entry command from a cellular network to a vehicle keyless entry receiver, said module comprising:
a cellular network receiver configured to receive a remote keyless entry command from a cellular network; and
a keyless entry transmitter located in the vehicle and in communication with the cellular network receiver, wherein said keyless entry transmitter is configured to transmit a remote keyless entry signal to a vehicle keyless entry receiver in the vehicle in order to execute a vehicle operation, wherein the remote keyless entry signal corresponds to the remote keyless entry command.

2. The module in accordance with claim 1, wherein the keyless entry transmitter includes a remote keyless entry key fob circuit board assembly, wherein the module is coupled to the remote keyless entry key fob circuit board assembly in a manner effective for the module to operate the remote keyless entry key fob circuit board assembly to transmit a remote keyless entry signal.

3. The module in accordance with claim 1, wherein the module is configured to communicate with cellular network via an in-vehicle cellular radio.

4. The module in accordance with claim 1, wherein the remote keyless entry command originates from a personal communication device in communication with the cellular network.

5. The module in accordance with claim 1, wherein the module is configured to send a confirmation message to the cell phone network.

6. A communication system for relaying a remote keyless entry command from a personal communications device to a vehicle keyless entry receiver, said system comprising:
a personal communication device configured to send a remote keyless entry command via a cellular network;
a cellular network receiver located in a vehicle, said cellular network receiver configured to receive the remote keyless entry command from the cellular network; and
a keyless entry transmitter located in the vehicle and in communication with the cellular network receiver, wherein said keyless entry transmitter is configured to transmit a remote keyless entry signal to a vehicle keyless entry receiver in the vehicle in order to execute a vehicle operation, wherein the remote keyless entry signal corresponds to the command message.

7. The system in accordance with claim 6, wherein the transmitter includes a remote keyless entry key fob circuit board assembly, wherein the cellular network receiver is coupled to the remote keyless entry key fob circuit board assembly in a manner effective for the cellular network receiver to operate the remote keyless entry key fob circuit board assembly to transmit a remote keyless entry signal.

8. The system in accordance with claim 6, wherein the system further comprises a cellular network transmitter configured to send a confirmation message to the personal communication device via the cellular network.
